(19) United States
(12) Patent Application Publication
(10) Pub. No.: US 2010/0010830 A1
(43) Pub. Date: Jan. 14, 2010

(54) TELEVISION FOR PROVIDING HEALTH INFORMATION

(75) Inventor: LUNG DAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/494,301

(22) Filed: Jun. 30, 2009

(30) Foreign Application Priority Data
Jul. 11, 2008 (CN) 200810302698.7

(51) Int. Cl. G06Q 50/00; H04N 5/45; H04N 5/44

(52) U.S. Cl. 705/2; 348/565; 348/734; 348/E05.112; 348/E05.096

(57) ABSTRACT

A television includes a memory, a health processor, and a health application stored in the memory. The health application is configured for execution by the health processor to receive body information inputted by the remote control, the body information being associated with a user watching the television programs; calculate a health index according to the received body information by the health processor; determine whether the calculated health index satisfies a standard index; and output an indicating message to the user upon determination that the calculated health index does not satisfy the standard index.

### BACKGROUND

1. Technical Field

The present disclosure relates to televisions (TVs), and more particularly to a television in association with a remote control for providing personal health information.

2. Description of Related Art

With technology and society developing, people may become more interested in their health. However, mechanisms to provide personal health information are inadequate or lacking. Therefore, it is desired to overcome the described shortcomings and deficiencies.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a television in association with a remote control in accordance with an exemplary embodiment.

FIG. 2 is a top view of the remote control of FIG. 1 in accordance with an exemplary embodiment.

FIG. 3 is a block diagram of the television of FIG. 1 in accordance with an exemplary embodiment.

FIG. 4 is a flowchart illustrating a method for providing health information in accordance with an exemplary embodiment.

FIG. 5 is a display of the television of FIG. 1 illustrating health information in accordance with an exemplary embodiment.

FIG. 6 is a display of the television of FIG. 1 illustrating an indicating message in accordance with an exemplary embodiment.

### DETAILED DESCRIPTION

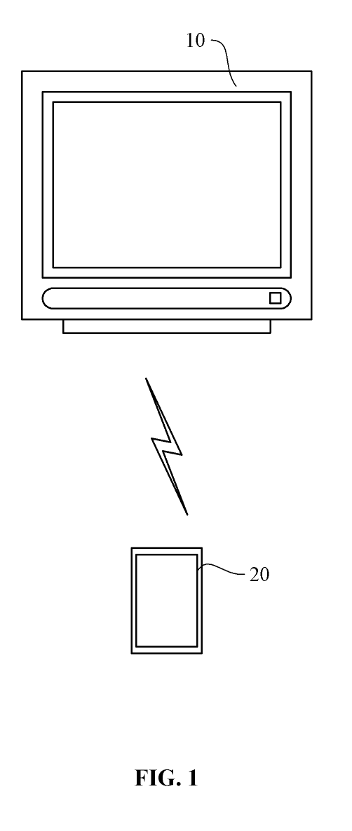

In general, the present disclosure provides a novel and non-obvious way of providing personal health information on a television. Referring to FIG. 1, a schematic diagram of a television 10 in association with a remote control 20 in accordance with an exemplary embodiment is illustrated. In a first mode or a normal mode, the television 10 may be controlled by the remote control 20 to adjust/change various settings, such as television channel and/or volume. Moreover, the remote control 20 may be configured in a second mode or a health mode. In the health mode, the remote control 20 may be operated to enter body information of a user to the television 10. As used herein, the “body information” may include a height and a weight of the user.

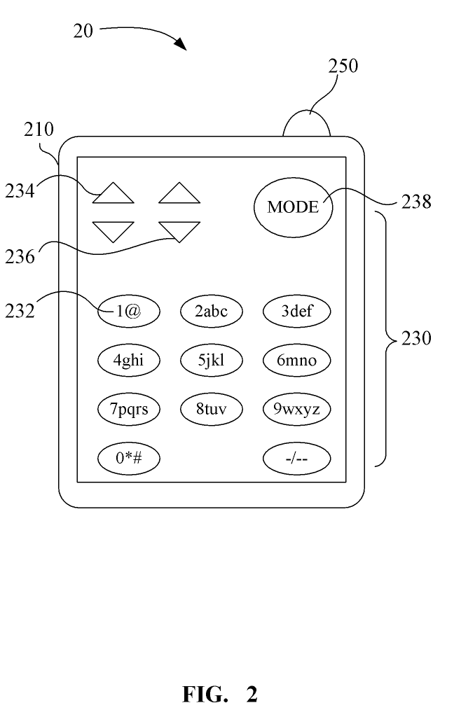

Referring to FIG. 2, a top view of the remote control 20 of FIG. 1 in accordance with an exemplary embodiment is illustrated. The remote control 20 may include a housing 210, a keypad 230, and a transmitter 250.

The housing 210 may include a structure to contain components of the remote control 20. For example, the housing 210 may be formed from plastic or metal and may support the display 220, the keypad 230, the speaker 240, and the transmitter 250.

The keypad 230 may include any component capable of providing inputs to the remote control 20. The keypad 230 may include a plurality of input keys 232. The plurality of input keys 232 are appropriately arranged like a telephone keypad. Each of the plurality of keys 232 is associated with a numeric number and multiple characters/letters. The keypad 230 may also include channel keys 234 and volume keys 236. The channel keys 234 are configured for selecting channels of the television 10. The volume keys 236 are configured for adjusting the volume of the television 10. The keypad 230 may further include a mode selection key 238. The mode selection key 238 may be appropriately arranged to change a mode of the remote control 20 between a normal mode and a health mode. When the mode selection key 238 is actuated to change the remote control 20 to the normal mode, the plurality of keys 232 may be operated to input a channel number of the television 10. When the mode selection key 238 is actuated to switch the remote control 20 to the health mode, the plurality of keys 232 may be operated to enter body information. In one implementation, each key of the keypad 230 may be, for example, a pushbutton, an area on a touch-sensitive screen, etc.

The transmitter 250 may include any component capable of issuing a command for transmitting operation to the television 10. In one implementation, the command is transmitted to the television 10 via infrared.

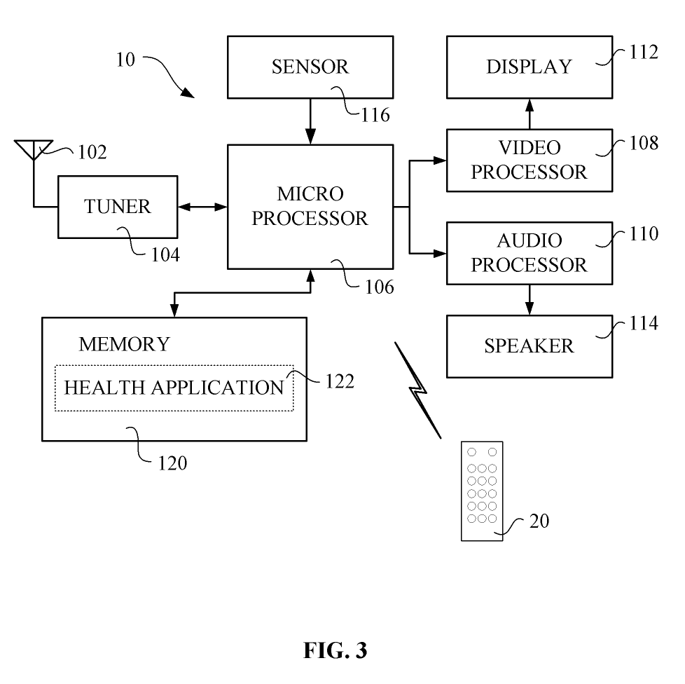

Referring to FIG. 3, a block diagram of the television 10 of in FIG. 1 is illustrated. As illustrated, the television 10 may include an antenna 102, a tuner 104, a microprocessor 106, a video processor 108, an audio processor 110, a display 112, a speaker 114, a sensor 116, and a memory 120.

The antenna 102 may include any component capable of receiving digital broadcasting signals. The digital broadcasting signals are transmitted in the form of electromagnetic carrier waves over the air at predetermined frequencies. The antenna 102 generates radio frequency (RF) signals based on the digital broadcasting signals.

The tuner 104 is coupled between the antenna 102 and the microprocessor 106. The tuner 104 may be a digital tuner for receiving channel selection signals from the microprocessor 106 in response to input commands from the remote control 20. The tuner 104 further converts selected RF signals into intermediate frequency (IF) signals, and demodulates the IF signals to generate digital baseband signals. The digital baseband signals generally include video data, audio data, and extended service data such as closed caption data.

The microprocessor 106 may include any logic that access instructions from the memory 260, and interprets and executes instructions to control the overall operation of the television 10. As used herein, the term “logic” may include hardware, software, and/or a combination of hardware and software. The microprocessor 106 may include, for example, a general-purpose processor, a microprocessor, a data processor, a co-processor, a network processor, an application specific integrated circuit (ASIC), a controller, a programmable logic device, a chipset, a field programmable gate array (FPGA), etc. The microprocessor 106 receives the digital baseband signals from the tuner 104, and processes the digital baseband signals to generate encoded video data and encoded audio data. The encoded video data may be encoded and/or compressed according to the MPEG-2 video standard. The encoded audio data may be encoded and/or compressed according to Dolby Digital audio standard.

The video processor 108 decompresses and/or decodes the encoded video data from the microprocessor 106 and provides decoded video signals representative a video portion of a program channel. The video portion of the television program is displayed by the display 112.

The audio processor 110 decompresses and/or decodes the encoded audio data from the microprocessor 106 and provides decoded audio signals representative an audio portion of a television program. The audio portion of the television program is outputted by the speaker 114.

The sensor 116 is configured to detect whether a user is in front of the television 10 in a predetermined range. In one implementation, the sensor 116 is an infrared sensor. When the sensor 116 detects that the user is in front of the television 10 in a predetermined range, the sensor 116 sends a confirmation signal to the microprocessor 106. In response to the confirmation signal, the microprocessor 106 calculates a time period that the user watches the television 10.

The memory 120 may include any type of storage component that stores data and instructions related to the operation and use of the remote control 20. For example, the memory 120 may include a memory component, such as a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

The memory 120 further stores a health application 122. The health application 122 contains software instructions. The software instructions may be read out of the memory 120 and may be interpreted and executed by the microprocessor 106 to perform various functions which will be described hereinafter.

Although FIG. 3 illustrates exemplary components, in other implementations, fewer, additional, and/or different internal components than the internal components depicted in FIG. 3 may be employed. For example, the television 10 may not include the speaker 114.

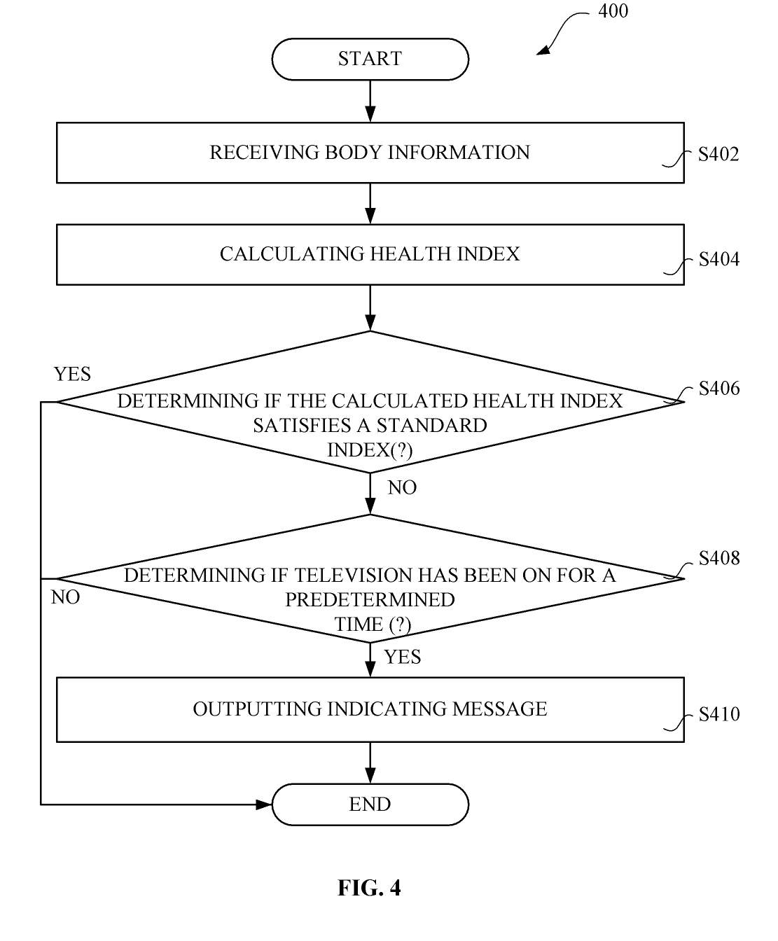

In operation, the remote control 20 may be operated to actuate the mode selection key 238, so as to change the remote control 20 to the health mode. When the television 100 is in the health mode, the health application 122 stored in the memory 120 may be invoked by the microprocessor 106 to perform various actions. Referring to FIG. 4, a flowchart illustrating a method 400 for providing personal health information includes the following steps.

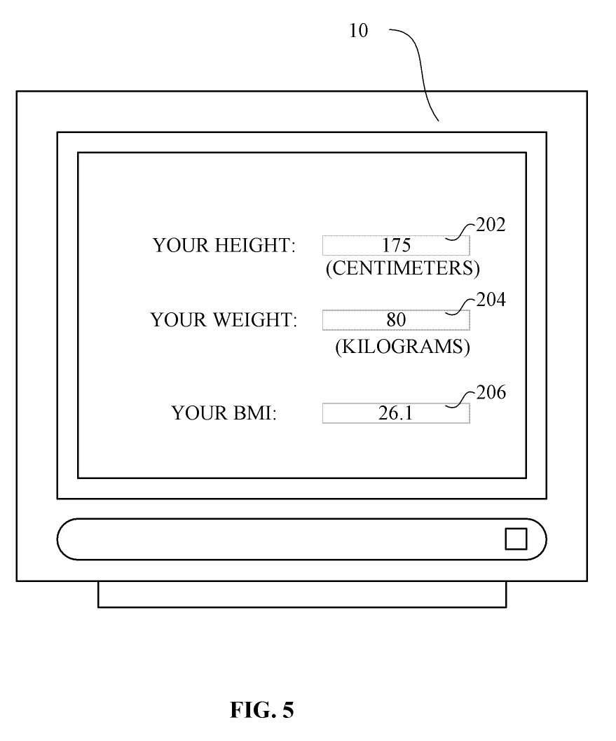

At step S402, body information is inputted by the remote control 20. Referring to FIG. 5, the television 10 may display a display interface 200 having a plurality of fields for inputting body information. In one implementation, the display interface 200 includes a first field 202 for inputting height, a second field 204 for inputting weight. For example, the user may input a height of one hundred and seventy five centimeters (175 cm) and a weight of eighty kilograms (80 kg) into the first field 202 and the second field 204 respectively.

At step S404, the microprocessor 106 of the television 10 calculates a health index. In one implementation, the health index is a body mass index (BMI). BMI is a measure of body fat based on height and weight that may apply to both adult men and women. The body mass index may be calculated according to the following equation (1):

BMI=G/H² (1)

wherein G is the weight, H is the height. As illustrated in FIG. 5, the display interface 200 further includes a third field 206 for displaying the BMI index calculated according to the equation (1).

At step S404, the microprocessor 106 determines whether the calculated health index satisfies a standard index. Upon determination that the calculated health index satisfies a standard index, the procedure goes to end. Upon determination that the calculated health index does not satisfy the standard index, the procedure goes to step S408. In one implementation, the standard index is corresponding to the BMI index. As shown in table I, the “standard index” corresponds to a normal weight with the index ranged between 18.5 and 24.9. When the calculated BMI is equal to or less than 18.5, the user is determined to be underweight. When the calculated BMI is ranged between 25 and 29.9, the user is determined to be overweight. When the calculated BMI is equal to or greater than 30, the user is determined to be obesity. The conditions of underweight, overweight and obesity are determined not satisfying the standard index.

TABLE I
BMI Categories

| BMI | Category |
|---|---|
| Equal to or less than 18.5 | Underweight |
| Between 18.5-24.9 | Normal weight (standard index) |
| Between 25-29.9 | Overweight |
| Equal to or greater than 30 | Obesity |

At step S408, the microprocessor 106 determines whether the television 10 has been ON for a predetermined time. In one implementation, the predetermined time may be one hour or two hours. When the sensor 116 detects that the user is in front of the television 10 in a predetermined range, the microprocessor 106 calculates a time that the television 10 has been ON. The microprocessor 106 compares the calculated time with the predetermined time to determine whether the television 10 has been ON for the predetermined time. Upon determination that the television 10 has been ON for a predetermined time, the procedure goes to step S410. Upon determination that the television 10 has not been ON for a predetermined time, the procedure goes to end.

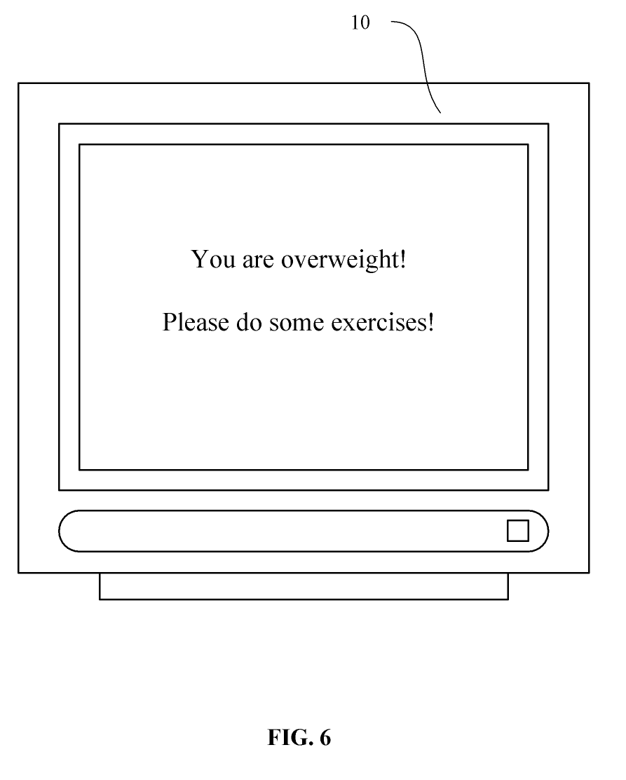

At step S410, the microprocessor 106 causes an indicating message to be outputted. In one implementation, the indicating message is visually outputted on the display 112. Referring to FIG. 6, when it is determined that the television 10 has been ON for a predetermined time, a message of “You are overweight! Please do some exercises!” is rendered to be displayed on the display 10. Furthermore, the indicating message may be simultaneously displayed with the television programs in a picture-in-picture (PIP) manner or a picture-on-picture (POP) manner. In other implementations, the indicating message may be audibly outputted by the speaker 114. Still in other implementations, the indicating message may be outputted in a repeated manner. For example, if the television 10 has been ON for four hours, the indicating message may be outputted every one hour.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A television capable of showing television programs, and capable of being controlled by a remote control, the television comprising:
a memory;
a health processor; and
a health application stored in the memory and configured for execution by the health processor; the health application comprising instructions to:
receive body information inputted by the remote control, the body information being associated with a user watching the television programs;
calculate a health index according to the received body information by the health processor;
determine whether the calculated health index satisfies a standard index; and
output an indicating message to the user upon determination that the calculated health index does not satisfy the standard index.

2. The television according to claim 1, further comprising a sensor configured to detect whether the user is in front of the television in a predetermined range, wherein the health application further comprises instructions to:
calculate a time that the television has been ON by the user in response to the user is detected to be present in front of the television in the predetermined range; and
determine whether the television has been ON for a predetermined time.

3. The television according to claim 1, wherein the health application further comprises instructions to:
repeatedly output the indicating message to the user upon determination that the television programs have been ON for a predetermined time.

4. The television according to claim 1, further comprising a display, wherein the indicating message is visually outputted to the user by the display.

5. The television according to claim 1, wherein the indicating message is simultaneously displayed with the television programs in a picture-in-picture manner.

6. The television according to claim 1, wherein the indicating message is simultaneously displayed with the television programs in a picture-on-picture manner.

7. The television according to claim 1, further comprising a speaker, wherein the indicating message is audibly outputted to the user by the speaker.

8. The television according to claim 1, wherein the body information comprises: a height and a weight of the user.

9. The television according to claim 8, wherein the health index is a body mass index (BMI), the body mass index is calculated by following equation: BMI=G/H², wherein G is the weight, H is the height.

10. A method for providing health information by a television, the television capable of showing television programs, and being controlled by a remote control, the method comprising:
receiving body information inputted by the remote control, the body information being associated with a user watching the television programs;
calculating a health index according to the received body information by the television;
determining whether the calculated health index satisfies a standard index by the television; and
outputting an indicating message to the user upon determination that the calculated health index does not satisfy the standard index.

11. The method according to claim 10, further comprising:
determining whether the television programs have been ON for a predetermined time; and
repeatedly outputting the indicating message to the user upon determination that the television programs have been ON for a predetermined time.

12. The method according to claim 10, wherein the action of outputting an indicating message further comprising:
visually outputting the indicating message to the user by a display of the television.

13. The method according to claim 12, wherein the action of visually outputting the indicating message further comprising:
simultaneously outputting the indicating message to the user with the television programs in a picture-in-picture manner.

14. The method according to claim 12, wherein the action of visually outputting the indicating message further comprising:
simultaneously outputting the indicating message to the user with the television programs in a picture-on-picture manner.

15. The method according to claim 10, wherein the action of outputting an indicating message further comprising:
audibly outputting the indicating message to the user by a speaker of the television.

16. A method for providing health information by a television, the television capable of showing television programs, and being controlled by a remote control, the method comprising:
receiving body information inputted by the remote control, the body information being associated with a user watching the television programs;
calculating a health index according to the received body information by the television;
determining whether the calculated health index satisfies a standard index by the television;
determining whether the television programs have been ON for a predetermined time; and
repeatedly outputting an indicating message to the user upon determination that the calculated health index does not satisfy the standard index and the television programs have been ON for a predetermined time.

17. The method according to claim 16, wherein the action of outputting an indicating message further comprising:
visually outputting the indicating message to the user by a display of the television.

18. The method according to claim 17, wherein the action of visually outputting the indicating message further comprising:
simultaneously outputting the indicating message to the user with the television programs in a picture-in-picture manner.

19. The method according to claim 17, wherein the action of visually outputting the indicating message further comprising:
simultaneously outputting the indicating message to the user with the television programs in a picture-on-picture manner.

20. The method according to claim 16, wherein the action of outputting an indicating message further comprising:
audibly outputting the indicating message to the user by a speaker of the television.
